(19) United States
(12) Patent Application Publication
(10) Pub. No.: US 2014/0156747 A1
(43) Pub. Date: Jun. 5, 2014

(54) OBTAINING SOCIAL NETWORKING SYSTEM USER ACTIONS FROM VISUAL REPRESENTATIONS ENCODING ACTION CHARACTERISTICS

(71) Applicant: Facebook, Inc., Menlo Park, CA (US)

(72) Inventors: David Schatz, New York, NY (US); Pedram Keyani, San Carlos, CA (US)

(21) Appl. No.: 13/693,034

(22) Filed: Dec. 3, 2012

(51) Int. Cl. H04L 29/08

(52) U.S. Cl. CPC H04L 67/22
USPC 709/204

(57) ABSTRACT

A user of a social networking system performs an action with a device associated with a terminal, and based on the action, the terminal displays a visual representation of machine-readable code (e.g., a QR code) that encodes information about the action or a link to a source for obtaining such information. The user captures the machine-readable code with a mobile device, and an application on the device obtains the information describing the action from the machine-readable, associates the information with the user's identifier and communicates the information and user identifier to the social networking system. Using the information describing the action, the social networking system may then publish an action, add to the user's user profile, and/or perform other tasks based on the received information.

### BACKGROUND

Embodiments of the present disclosure generally relate to social networking, and, more specifically, to communicating data about external activities to a social networking system.

Social networks, or social utilities that track and enable connections between users (including people, businesses, and other entities), have become prevalent. A social networking system allows its users to more efficiently communicate information relevant to their friends or other users or objects connected to a user via the social networking system. To allow distribution of information, a social networking system typically maintains connections among its users as well as information for identifying content likely to be relevant to the users. A social networking system also collects and maintains information about its users. This information may be static, such as geographic location, employer, job type, age, music preferences, interests, and a variety of other attributes, or it may be dynamic, such as tracking a user's actions within the social network system. This information can then be used to target information delivery so that information more likely to be of particular interest to a user can be communicated to that user.

Social networking system users perform a variety of interactions with devices or entities outside of the social networking system. Information describing these interactions may be communicated to the social networking system, which may distribute a description of an interaction to other users connected to the user or use the interaction to select content for the user. For example, a social networking system user purchases goods or services from a vendor's retail location or from a website outside of the social networking system associated with the vendor and communicate a description of the purchase to the social networking system. Including descriptions of interactions external to the social networking system allows the social networking system to better select content for its users and to increase information communicated between social networking system users.

Social networking system users engage in various activities outside of the social networking system, such as running on a treadmill, playing a video game, or taking a photo at a photo booth. These activities provide information about the user but are not readily communicated to the social networking system. Including descriptions of these activities in the social networking system would increase the information associated with a user stored by the social networking system, allowing the social networking system to more accurately identify a user's interests or to increase the information communicated between its users.

### SUMMARY

To simplify communication of an action outside of the social networking system to the social networking system, a visual representation describing an action external to the social networking system is generated and displayed by a terminal that is proximate to the social networking system user. For example, data describing an action is encoded using a visual representation of a machine-readable code, such as a quick response code (a “QR” code), that encodes information about the action or encodes a link to a source for obtaining that information. Examples of terminals displaying a visual representation describing an action include: exercise equipment, receipts for a purchase of a product or service, restaurant menus, a computer display device, and any other suitable device or medium.

A social networking system user uses a client device, such as a mobile device, to capture the visual representation of the machine-readable code and generate a description of the action based on the machine-readable code. The client device also associates the description of the action with a user of the client device. Alternatively, a terminal communicates a description of an action to a client device using near field communication (NFC), infrared communication, or via another suitable communication channel. For example, an application executing on the client device decodes the visual representation to obtain the description of the action. As another example, an application executing on the client device extracts an address from the visual representation and accesses a website associated with the address to obtain the description of the action. The user's mobile device then transmits information about the action extracted from the visual representation along with an identifier of the user to the social networking system. In one embodiment, the application is a social networking application executing on the user's mobile device is uniquely associated with the user because the user is logged into the social networking system application and provides the identifier of the user that is transmitted. Alternatively, the user provides identifying information via the application when the application obtains the description of the action from the machine-readable code; the application may further authenticate the user in some embodiments. Using the identifier, the social networking system identifies a user profile associated with the description of the action. The social networking system then stores the description of the action and a connection between the description of the action and the identified user profile.

The social networking system may use this information in various ways, such as by distributing the description of the action to other users connected to the user associated with the description of the action or otherwise communicate the description of the action to entities maintained by the social networking system. For example, the social networking system may identify an additional entity associated with the action from the description of the action and communicate information about multiple descriptions of actions associated with the entity to the entity. The information communicated to the entity may remove associations between users and the descriptions of actions, so that the entity is unable to correlate actions with individual users.

### BRIEF DESCRIPTION OF THE DRAWINGS

FIG. 1 is a system environment for communicating a description of a user action to a social networking system, in an embodiment of the invention.

FIG. 2 is a block diagram of a system architecture for a social networking system, in an embodiment of the invention.

FIG. 3 is an interaction diagram of a method for communicating a description of a user action from a terminal to a social networking system, in an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

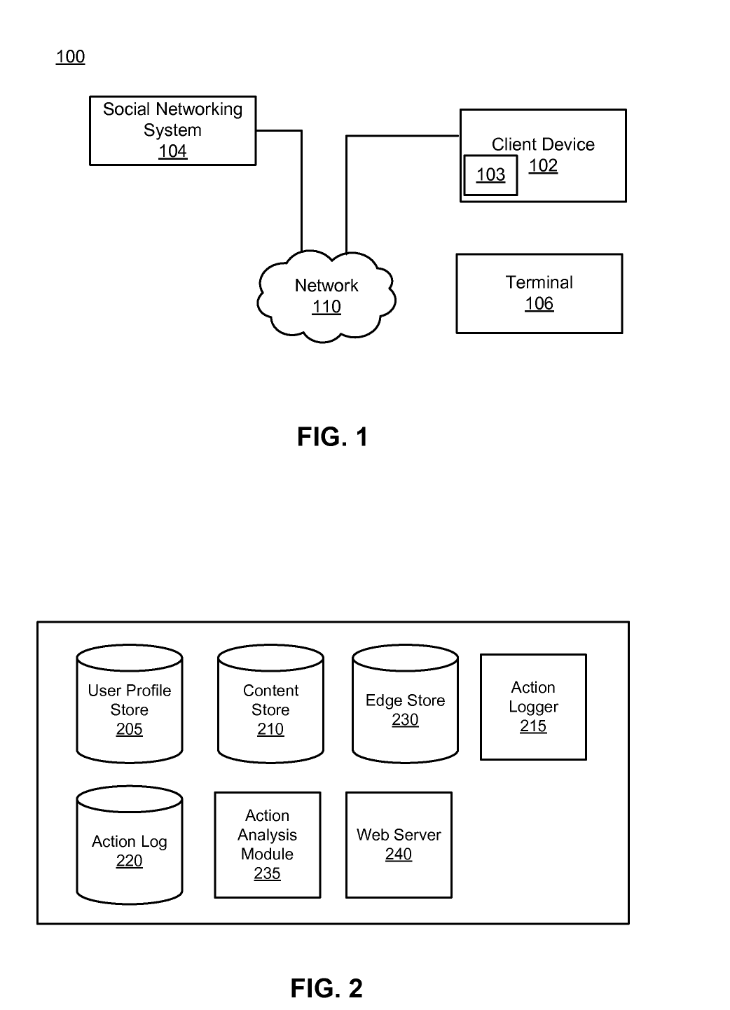

FIG. 1 is a high level block diagram illustrating a system environment 100 for communicating a description of a user's action to a social networking system 104. The system environment 100 includes a client device 102, the social networking system 104, a terminal 106 and a network 110. In alternative configurations, different and/or additional components may be included in the system environment 100. The embodiments described herein can be adapted to online systems that are not social networking systems.

The client device 102 is a computing device capable of receiving user input as well as transmitting and/or receiving data via the network 110. In one embodiment, the client device 102 is a conventional computer system, such as a desktop or laptop computer. In another embodiment, the client device 102 may be a device having computing functionality, such as a personal digital assistant (PDA), mobile telephone, smart-phone or similar device. The client device 102 is configured to communicate with the social networking system 104 via the network 110. In one embodiment, the client device 102 executes a browser application to enable interaction between the client device 102 and the social networking system 104 via the network 110. Alternatively, the client device 102 executes an application allowing a user of the client device 102 to interact with the social networking system 104. In another embodiment, the client device 102 interacts with the social networking system 104 through an application programming interface (API) that runs on the native operating system of the client device 102, such as IOS® or ANDROID™.

The client device 102 is uniquely associated with a user of the social networking system 104 using an application executing on the client device 102. This allows information from the client device 102 to be associated with the user of the social networking system 104. In one embodiment, the application is a social networking application executing on the client device, and the user is uniquely associated with the social networking system 104 by being logged into the social networking system application. Alternatively, the user provides identifying information to an application executing on the client device 102, and the information is communicated to the social networking system 104 to identify the user. The application or the social networking system 104 may apply one or more authentication processes to the identifying information.

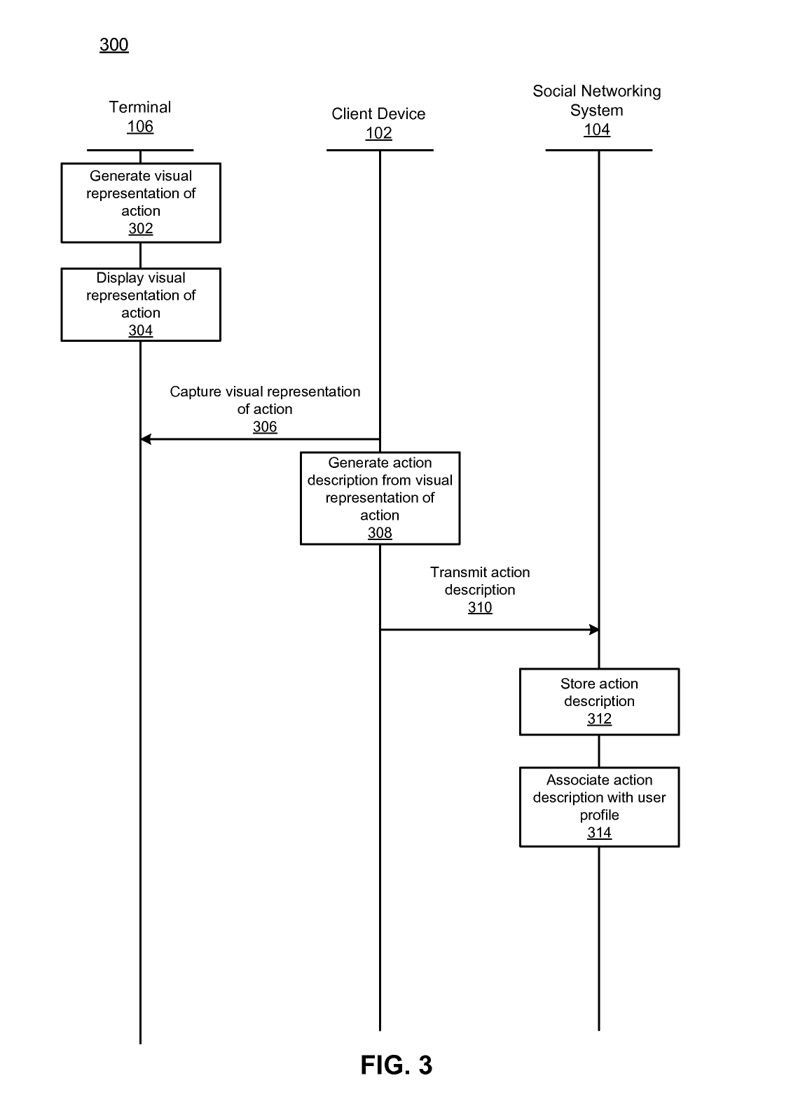

Additionally, the client device 102 includes an image capture device 103, such as a camera or a video camera. The image capture device 103 captures images of objects in an environment external to the client device 102. One or more applications or firmware executed by the client device 102 process image data captured by the image capture device 103. An application or a portion of the firmware executed by the client device may extract information encoded in image data captured the image capture device 103. In one embodiment, the image capture device 103 captures an image including a visual representation of data and an application executing on the client device 102 extracts information from the visual representation of data. For example, the image capture device 103 captures an image including a quick response (QR) code or a bar code, and an application executed by the client device 102 extracts information from the QR code or from the bar code. As further described below in conjunction with FIG. 3, information extracted from a visual representation of data may be communicated from the client device 102 to the social networking system 104 via the network 110.

The social networking system 104, further described below in conjunction with FIG. 2, comprises one or more computing devices storing user profiles associated with users and/or objects as well as connections between users and other users and/or objects. In use, users join the social networking system 104 and then add connections to other users or objects of the social networking system 104 to which they desire to be connected. Users of the social networking system 104 may be individuals or entities such as businesses, organizations, universities, and/or manufacturers.

The client device 102 is configured to communicate via the network 110, which may comprise any combination of local area and/or wide area networks, using both wired and wireless communication systems. In one embodiment, the network 110 uses standard communications technologies and/or protocols. Thus, the network 110 may include links using technologies such as Ethernet, 802.11, worldwide interoperability for microwave access (WiMAX), 3G, 4G, CDMA, digital subscriber line (DSL), etc. Similarly, the networking protocols used on the network 110 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 110 may be represented using technologies and/or formats including hypertext markup language (HTML) or extensible markup language (XML). In addition, all or some of links can be encrypted using conventional encryption technologies such as secure sockets layer (SSL), transport layer security (TLS), and Internet Protocol security (IPsec).

The terminal 106 is any device or medium capable of displaying a visual representation of data, such as a visual representation of an action performed by a user. The visual representation of data may be a machine-readable code, such as a quick response (QR) code or a barcode, from which a description of the action may be extracted by an application or firmware executing by a client device 102. In one embodiment, the terminal 106 is a display screen of a device with which a user interacts. For example, the terminal 106 is a display screen of an item of exercise equipment or of a kiosk. As another example, the terminal 106 is a receipt or other document generated and provided by an entity such as a restaurant or retail location. Hence, the terminal 106 presents a visual representation of an action performed by a user that involves an entity associated with the terminal 106 and/or a device including the terminal 106. As described below in conjunction with FIG. 3, capturing the visual representation of the action using the image capture device 103 of the client device 102 allows the user to easily generate a description of the user's action for communication to the social networking system 104.

### Social Networking System Architecture

FIG. 2 is a block diagram of a system architecture of the social networking system 104. The social networking system 104 shown by FIG. 2 includes a user profile store 205, a content store 210, an action logger 215, an action log 220, an edge store 230, a data analysis module 235, and a web server 240. In other embodiments, the social networking system 104 may include additional, fewer, or different components for various applications. Conventional components such as network interfaces, security functions, load balancers, failover servers, management and network operations consoles, and the like are not shown so as to not obscure the details of the system architecture.

Each user of the social networking system 104 is associated with a user profile, which is stored in the user profile store 205. A user profile includes declarative information about the user that was explicitly shared by the user, and may also include profile information inferred by the social networking system 104. In one embodiment, a user profile includes multiple data fields, each data field describing one or more attributes of the corresponding user of the social networking system 104. The user profile information stored in user profile store 205 describes the users of the social networking system 104, including biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the social networking system 104 displayed in an image. A user profile in the user profile store 205 may also maintain references to actions by the corresponding user performed on content items in the content store 210 and stored in the action log 220.

While user profiles in the user profile store 205 are frequently associated with individuals, allowing people to interact with each other via the social networking system 104, user profiles may also be stored for entities such as businesses or organizations. This allows an entity to establish a presence on the social networking system 104 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects representing various types of content. Examples of content represented by an object include a page post, a status update, a photo, a video, a link, a shared content item, a gaming application achievement, a check-in event at a local business, a brand page, or any other type of content. Objects may be created by users of the social networking system 104, such as status updates, photos tagged by users to be associated with other objects in the social networking system, events, groups or applications. In some embodiments, objects are received from third-party applications or third-party applications separate from the social networking system 104. Content “items” represent single pieces of content that are represented as objects in the social networking system 104. Users of the social networking system 104 are encouraged to communicate with each other by posting text and content items of various types of media through various communication channels, increasing the interaction of users with each other and increasing the frequency with which users interact within the social networking system.

The action logger 215 receives communications about user actions on and/or off the social networking system 104, populating the action log 220 with information about user actions. Such actions may include, for example, adding a connection to another user, sending a message to another user, uploading an image, reading a message from another user, viewing content associated with another user, attending an event posted by another user, among others. In some embodiments, the action logger 215 identifies interaction between a social networking system user and a brand page within the social networking system 104, allowing customization of content provided to the social networking system via the brand page. In addition, a number of actions described in connection with other objects are directed at particular users, so these actions are associated with those users as well. These actions are stored in the action log 220.

Descriptions of actions may be received by the web server 240 and communicated to the action logger 215, which stores a received description of an action in the action log 220. This allows a user to describe an action performed outside of the social networking system 104 using a client device 102, which is stored by the action log 220 to provide more detailed information about the user. A description of an action may be generated by a client device 102 from information captured by the client device 102, such as from a visual representation of data captured by an image capture device 103 of the client device 102. A description of an action may comprise a delimited list including an identifier of an application or entity associated with the action and data describing the action, such as an action type, characteristics of the action or other suitable data. Examples of actions external to the social networking system 104 for which a description of the action may be received and stored include a user exercising using exercising equipment, accessing content from a kiosk, making a purchase at a retail location or another suitable action.

The action log 220 may be used by the social networking system 104 to track user actions on the social networking system 104, as well as external website that communicate information to the social networking system 104. Users may interact with various objects on the social networking system 104, including commenting on posts, sharing links, and checking-in to physical locations via a mobile device, accessing content items or other interactions. Information describing these actions is stored in the action log 220. Additional examples of interactions with objects on the social networking system 104 included in the action log 220 include commenting on a photo album, communications between users, becoming a fan of a musician, adding an event to a calendar, joining a groups, becoming a fan of a brand page, creating an event, authorizing an application, using an application and engaging in a transaction. Additionally, the action log 220 records a user's interactions with advertisements on the social networking system 104 as well as other applications operating on the social networking system 104. In some embodiments, data from the action log 220 is used to infer interests or preferences of the user, augmenting the interests included in the user profile and allowing a more complete understanding of user preferences.

The action log 220 may also store user actions taken on external websites. For example, an e-commerce website that primarily sells sporting equipment at bargain prices may recognize a user of a social networking system 104 through social plug-ins that enable the e-commerce website, or another external website, to identify the user of the social networking system 104. Because users of the social networking system 104 are uniquely identifiable, e-commerce websites, such as this sporting equipment retailer, may use the information about these users as they visit their websites. The action log 220 records data about these users, including webpage viewing histories, advertisements that were engaged, purchases made, and other patterns from shopping and buying.

In one embodiment, an edge store 230 stores the information describing connections between users and other objects on the social networking system 104 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 104, such as expressing interest in a page on the social networking system, sharing a link with other users of the social networking system, and commenting on posts made by other users of the social networking system.

The edge store 230 stores edge objects that include information about the edge, such as affinity scores for objects, interests, and other users. Affinity scores may be computed by the social networking system 104 over time to approximate a user's affinity for an object, interest, and other users in the social networking system 104 based on the actions performed by the user. A user's affinity may be computed by the social networking system 104 over time to approximate a user's affinity for an object, interest, and other users in the social networking system 104 based on the actions performed by the user. Computation of affinity is further described in U.S. patent application Ser. No. 12/978,265, filed on Dec. 23, 2010, which is hereby incorporated by reference in its entirety. Multiple interactions between a user and a specific object may be stored in one edge object in the edge store 230, in one embodiment. In some embodiments, connections between users may be stored in the user profile store 205, or the user profile store 205 may access the edge store 230 to determine connections between users.

In one embodiment, the social networking system 104 includes an action analysis module 235 that retrieves data describing actions from the action log 220 associated with one or more users and extracts characteristics of the retrieved actions. For example, the action analysis module 235 retrieves actions associated with a specified entity and generates a summary of the actions for communication to the entity. In one embodiment, the action analysis module 235 removes information associating actions with users when generating a summary for an entity, allowing the entity to receive information about actions while preserving users' anonymity. The action analysis module 235 may also generate suggestions for actions or identify entities to a user based on descriptions of actions associated with a user. Similarly, the action analysis module 235 may be used by the social networking system 104 to select advertisements for presentation to a user based on descriptions of actions associated with the user.

The web server 240 links the social networking system 104 via the network 120 to the one or more client devices 110, as well as to one or more third party websites. The web server 240 serves web pages, as well as other web-related content, such as JAVA®, FLASH®, extensible markup language (XML) and so forth. The web server 240 may provide the functionality of receiving and routing messages between the social networking system 104 and the client device 110, for example, instant messages, queued messages (e.g., email), text and SMS (short message service) messages, or messages sent using any other suitable messaging technique. A user may send a request to the web server 240 to upload information, for example, images or videos that are stored in the content store 210. Additionally, the web server 240 may provide API functionality to send data directly to native client device operating systems, such as IOS®, ANDROID™, WEBOS® or RIM.

### Transmitting Descriptions of Actions to a Social Networking System

FIG. 3 is an interaction diagram of one embodiment of a method 300 for communicating a description of a user action from a terminal 106 to a social networking system 104. Initially, a visual representation of an action by a user of the social networking system 104 is generated 302. While FIG. 3 shows an embodiment where the terminal 106 generates 302 a machine-readable code representing the action. For example, the terminal 106 generate 302 a visual representation of the action, in other embodiments an entity associated with the terminal generates 302 the visual representation of the action or other machine-readable code. The machine-readable code encodes characteristics of the action. For example, the machine-readable code representing the action is a quick response (QR) code that encodes an identifier of an entity associated with the action and various characteristics describing the action. Example characteristics describing the action include an action type, a timestamp associated with the action, a duration of the action or any other suitable data. The characteristics encoded in the machine-readable code of the action may vary depending on the action type. For example, for a terminal 106 that is a display screen of an exercise machine, the machine-readable code may encode one or more of: a manufacturer identifier, a model identifier, a serial number, an entity associated with the exercise machine, a duration of use, an intensity level unique unit number, workout statistics or other suitable information. Alternatively, the machine-readable code representing the action is a QR code encoding a uniform resource locator (URL) or other address of a system from which characteristics of the action are retrieved. Alternatively, the machine-readable code may be information transmitted from the terminal 106 to a client device 102 via near field communication (NFC), BLUETOOTH®, infrared, or any other suitable transmission method.

A variety of formats may be used to generate 302 the machine-readable code representing an action. For example, the machine-readable code representing the action may be generated 302 from a set of required characteristics and may include additional optional characteristics. In one embodiment, different applications associated with various terminals 106 may differently encode characteristics of an action, allowing application-specific generation of visual representations of an action. For example, an application communicates with the social networking system 104 identifying how the application generates 302 a machine-readable code representing an action.

The machine-readable code representing the action is displayed 304 by the terminal 106. For example, the machine-readable code representing the action is displayed 304 on a display screen of a device. Examples of devices include exercise equipment, a computer, a kiosk terminal, a television, or any other suitable device. Alternatively, the visual representation of the action is displayed 304 on a physical medium associated with an entity. For example, the machine-readable code representing the action is displayed 304 on a receipt generated by a retailer or a restaurant or is displayed 304 on another publication associated with an entity. Additional information may be included in the machine readable code representing the action or in another representation of an action communicated by a terminal 106. Examples of additional information include metadata describing an object associated with the action, metadata identifying the terminal or providing other tracking information, a reference to a networking address (e.g., a URL) to be accessed by the social networking system 104 if an object is created based on the data from the terminal 106, or any other suitable data.

Using a client device 102, a user captures 306 a visual representation of the machine-readable code representing the action from the terminal 106. For example, the client device 102 captures an image of the machine-readable code representing the action using an image capture device 103. While FIG. 3 describes capturing 306 a visual representation of the machine-readable code representing the action using an image capture device 103 of a client device 102, in an alternative embodiment, the client device 102 captures a description of the action from the terminal 106 using near-field communication (NFC) or another suitable communication method. In such embodiments, the terminal 106 and the client device 102 each include an NFC transceiver when the client device 102 is within a threshold distance of the NFC transceiver of the terminal 106.

An application, or firmware, operating on the client device 102 generates 308 a description of the action from the captured visual representation of the machine-readable code representing the action. For example, an application executing on the client device 102 decodes a QR code captured by the image capture device 103 of the client device 102 and generates 308 a description of the action from the characteristics decoded from the QR code. As another example, an application extracts a URL or other address from a QR code and accesses a system associated with the URL or other address to obtain information used to generate 308 the description of the action.

In one embodiment, the application or firmware operating on the client device 102 communicates a confirmation to the terminal 106 when the visual representation of the machine-readable code or the description of the action is received from the terminal 106. For example, the application or firmware may communicate a client device identifier, an object identifier of an object maintained by the social networking system 104, an address to a network location, or other suitable information indicating receipt of the visual representation or action description by the client device 102. Transmission of a confirmation to the terminal 106 may allow tracking of information communicated by the terminal 106 or determination of whether information was successfully received by the client device 102, which may allow the terminal 106 to attempt to provide the description of the action or visual representation via an alternative communication channel if no confirmation is received.

The description of the action is transmitted 310 from the client device 102 to the social networking system 104 via the network 110. A user identifier of the user of the client device 102 is transmitted 310 to the social networking system 104. For example, the user stores login information for the social networking system 104 for accessing the social networking system 104 via the client device 102 and the login information is transmitted 310 along with the description of the action, allowing the social networking system 104 to identify the user. As another example, the user provides a user identifier or other identifying information to the client device 102 and the provided user identification information is transmitted 310 along with the description of the action to the social networking system 104.

Upon receiving the description of the action and the user identifier, the social networking system 104 stores 312 the description of the action in the action log 220. The social networking system 104 also identifies a user profile corresponding to the user identifier and associates 314 the user profile with the action description by storing a connection between the user profile and the stored action description in the edge store 230. Hence, the social networking system 104 identifies the user associated with, or performing, the action as well as the description of the action. This allows the social networking system 104 to increase the amount of information associated with the user without requiring the user to manually describe its actions.

The stored action description may be used to provide additional content to its associated user. For example, the social networking system 104 may account for characteristics from the action description when selecting advertisements, links, stories or other content for presentation to the user. Additionally, the social networking system 104 may generate a story identifying the action description and its associated user and distribute the generated story to additional social networking system users connected to the user associated with the action description.

In some embodiments, the social networking system 104 may analyze received action descriptions and provide analysis results to an entity associated with the action descriptions. For example, the social networking system 104 retrieves action descriptions identifying a particular entity and generates summary information from the action descriptions, such as a description of the different action types associated with the entity, percentages of different action types associated with the entity, aggregated characteristics associated with various action descriptions. The summary information is communicated to the entity associated with the action descriptions. In one embodiment, the social networking system 104 does not include associations between action descriptions and users when generating the summary information, so the entity is unable to associate users with action descriptions or with information from action descriptions.

Hence, a social networking user may identify performed actions to a social networking system 104 by capturing data describing an action from a terminal 106 using a client device 102. For example, a machine-readable code representing the action is generated by the terminal 106 by encoding characteristics of the action. A visual representation of the machine-readable code representing the action is captured by the client device 102 (e.g., by capturing an image of the visual representation of the action), which extracts the characteristics of the action from the visual representation of the machine-readable code representing the action to generate an action description. The generated action description may then be communicated to the social networking system 104, allowing the action description to be stored.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
capturing a visual representation of a machine-readable code from a terminal, the machine-readable code encoding a description of an action performed at the terminal;
decoding information about the action from the machine-readable code;
associating a user identifier with the description of the action, the user identifier corresponding to a user of the social networking system; and
transmitting the information about the action and the user identifier to the social networking system for storing the description of the action and a connection between the information about the action and a user profile of the user.

2. The method of claim 1, wherein generating the description of the action by decoding the visual representation comprises:
extracting characteristics of the action from the visual representation.

3. The method of claim 1, wherein generating the description of the action by decoding the visual representation comprises:
extracting a uniform resource locator (URL) of a system from the visual representation;
accessing the system using the extracted URL; and
receiving characteristics of the action from the system.

4. The method of claim 1, wherein the visual representation of the action comprises a machine-readable code.

5. The method of claim 4, wherein the machine-readable code comprises a quick response (QR) code.

6. The method of claim 5, wherein the QR code encodes at least one of: a delimited listing of characteristics of the action and a uniform resource locator (URL) of a system from which the characteristics of the action are retrieved.

7. The method of claim 1, wherein associating the user identifier with the description of the action comprises:
retrieving a user identifier of a user logged into the social networking system using an application that decodes the information about the action from the machine-readable code.

8. The method of claim 1, wherein associating the user identifier with the description of the action comprises:
receiving login credentials from a user via an application that decodes the information about the action from the machine-readable code.

9. A method comprising:
receiving, at a social networking system, information about an action and an identifier of a user of the social networking system from a client device, the information about the action generated by the client device by decoding the information about the action from a machine-readable code displayed by a terminal;
determining a user profile associated with the identifier of the user of the social networking system, the user profile maintained by the social networking system;
storing the description of the action in the social networking system; and
storing a connection between the user account and the description of the action in the social networking system.

10. The method of claim 9, wherein the machine-readable code is a quick response (QR) code encoding characteristics of the action.

11. The method of claim 10, wherein the QR code includes a delimited listing of characteristics of the action.

12. The method of claim 11, wherein the delimited listing of characteristics of the action includes at least one of an identifier of an entity associated with the action or an identifier of a device associated with the action.

13. The method of claim 10, wherein the QR code encodes a uniform resource locator (URL) of a system from which the description of the action is retrieved.

14. The method of claim 9, further comprising:
presenting a story including the information about the action and the user of the social networking system to an additional user of the social networking system connected to the user of the social networking system.

15. The method of claim 9, further comprising:
determining an entity associated with the information about the action;
retrieving additional information about actions associated with the entity;
generating a summary of the additional information about actions associated with the entity; and
providing the summary to the entity.

16. The method of claim 15, wherein generating the summary of the additional information about actions associated with the entity comprises:
modifying the additional information about actions to remove information identifying users associated with the additional information about actions; and
generating the summary from the modified additional information about actions.

17. The method of claim 9, wherein the terminal is a display screen of a device associated with the action.

18. The method of claim 9, wherein the machine-readable code is generated on a receipt printed by the terminal by an entity associated with the action.

19. A method comprising:
receiving, at a social networking system, information about an action and an identifier of a user of the social networking system from a client device, the information about the action generated from data retrieved from a terminal by a client device;
determining a user profile associated with the identifier of the user of the social networking system, the user profile maintained by the social networking system;
storing the description of the action in the social networking system; and
storing a connection between the user account and the information about the action in the social networking system.

20. The method of claim 19, wherein the data retrieved from the terminal by the client device comprises a visual representation of the action captured by the client device.

21. The method of claim 20, wherein the visual representation of the action comprises a machine-readable code

22. The method of claim 21, wherein the machine-readable code is a quick response (QR) code encoding characteristics of the action.

23. The method of claim 19, wherein the data retrieved from the terminal by the client device comprises data retrieved from the terminal via near field communication.

24. The method of claim 19, wherein the terminal is a display screen of a device associated with the action.

25. The method of claim 19, wherein the terminal is a receipt generated by an entity associated with the action.

26. A method comprising:
receiving an interaction from a user of a social networking system;
generating a machine-readable code encoding information about the action; and
communicating the machine-readable code to a device associated with the user of the social networking system for generating a description of the action that is associated with the user of the social networking system by the device associated with the user.
